(19) United States
(12) Patent Application Publication
(10) Pub. No.: US 2022/0352758 A1
(43) Pub. Date: Nov. 3, 2022

(54) APPARATUSES AND METHODS FOR WIRELESSLY TRANSMITTING AND RECEIVING POWER

(71) Applicant: Electronics and Telecommunications Research Institute, Daejeon (KR)

(72) Inventors: Sang-Won KIM, Daejeon (KR); Gwangzeen KO, Daejeon (KR); Seong-Min KIM, Daejeon (KR); Jung Ick MOON, Daejeon (KR)

(73) Assignee: Electronics and Telecommunications Research Institute, Daejeon (KR)

(21) Appl. No.: 17/581,284

(22) Filed: Jan. 21, 2022

(30) Foreign Application Priority Data
Apr. 30, 2021 (KR) 10-2021-0056566

(51) Int. Cl. H02J 50/12; H02J 50/70; H02J 50/80

(52) U.S. Cl. CPC H02J 50/12; H02J 50/70; H02J 50/80

(57) ABSTRACT

An apparatus and method for wirelessly transmitting power and an apparatus and method for wirelessly receiving power are provided. A wireless power reception apparatus may include a reception circuit that is configured to wirelessly receive power having an extended frequency band and that includes a matching inductor with an adjusted inductance and a matching capacitor with an adjusted capacitance, and a processor configured to determine reception parameters related to a resonant frequency of the reception circuit based on transmission parameters and control the inductance and the capacitance based on the reception parameters, and the transmission parameters may be related to a variation in a transmission frequency at which the power is wirelessly transmitted.

### CROSS-REFERENCE TO RELATED APPLICATION

This application claims the benefit of Korean Patent Application No. 10-2021-0056566 filed on Apr. 30, 2021, in the Korean Intellectual Property Office, the entire disclosure of which is incorporated herein by reference for all purposes.

### BACKGROUND

### 1. Field of the Invention

One or more example embodiments relate to an apparatus and method for wirelessly transmitting power, and an apparatus and method for wirelessly receiving power.

### 2. Description of the Related Art

Wireless power transmission technologies and wireless charging technologies are being actively used in small Internet of things (IoT) devices, for example, smartwatches or mobile phones requiring low power less than 15 watts (W).

Wireless power transmission technologies may include, for example, a magnetic induction method, a magnetic resonance method, a long-distance microwave method, and the like.

The electromagnetic wave standards required in wireless power transmission and wireless charging systems need to be satisfied. Low-power wireless charging devices are being manufactured and developed to satisfy EMF/EMC standards through electromagnetic wave compatibility tests that are based on effects on human bodies.

However, in the case of a wireless charging system requiring medium power of several hundreds of W or greater, or high power of a few kilowatts (kW) or greater, it is difficult to satisfy the EMF/EMC standards, and an efficiency of a system is reduced.

### SUMMARY

According to various example embodiments, a wireless power transmission apparatus may wirelessly transmit power that has an extended bandwidth and that is randomly or sequentially variable at a transmission frequency.

According to various example embodiments, a wireless power reception apparatus may wirelessly receive power that has an extended bandwidth and that is randomly or sequentially variable, and may determine reception parameters based on transmission parameters, to increase a wireless power reception efficiency.

According to various example embodiments, a fundamental frequency component may be reduced in comparison to an existing wireless power transmission/reception system for a transmission at a single frequency, to reduce EMF/EMC electromagnetic wave emission.

According to various example embodiments, in a method of generating a transmission frequency, transmission parameters may be defined in advance, and a wireless power transmission apparatus may wirelessly transmit power at a transmission frequency variable depending on the transmission parameters.

According to various example embodiments, a wireless power reception apparatus may determine reception parameters related to a resonant frequency of a reception circuit according to transmission parameters, that is, reception parameters related to matching of the reception circuit or a matching inductor, to increase a wireless power reception efficiency.

According to various example embodiments, a method of randomly setting a frequency similar to a frequency hopping method or randomly generating a frequency band based on probability weights for each frequency, or a method of continuously changing a frequency within a specific bandwidth may be provided as a spread spectrum method, and a frequency setting interval and a duration may be uniform or set, thereby reducing electromagnetic wave emission.

According to various example embodiments, a wireless power transmitter, a wireless power receiver, and a wireless power transmission/reception system may be provided to prevent a decrease in an efficiency of a system by matching reception coils in real time based on a transmission frequency while using a frequency spreading scheme through transmission frequency modulation for reducing electromagnetic waves of a wireless power transmission and wireless charging system, in particular, for reducing EMF components.

According to an aspect, there is provided a wireless power reception apparatus including a reception circuit configured to wirelessly receive power having an extended frequency band, the reception circuit including a matching inductor with an adjusted inductance and a matching capacitor with an adjusted capacitance, and a processor configured to determine reception parameters related to a resonant frequency of the reception circuit based on transmission parameters and control the inductance and the capacitance based on the reception parameters, wherein the transmission parameters are related to a variation in a transmission frequency at which the power is wirelessly transmitted.

The processor may be configured to identify the transmission parameters received in the reception circuit during a communication period, and determine the reception parameters during a power period using the transmission parameters.

The processor may be configured to detect a current applied to the matching inductor, extract a frequency component of the current, and identify the transmission parameters.

The processor may be configured to determine the reception parameters based on a matching table in which the reception parameters corresponding to each of the transmission parameters are determined in advance.

The matching inductor may include a plurality of inductors, and a first switch block configured to control the inductance of the matching inductor by combining connections of the plurality of inductors.

The matching capacitor may include a plurality of capacitor banks, and a second switch block configured to control the capacitance of the matching capacitor by combining connections of the plurality of capacitor banks.

The matching capacitor may include a plurality of capacitors connected in parallel, and a plurality of duty switches connected to each of the plurality of capacitors and configured to control the capacitance of the matching capacitor by changing an effective capacitance of each of the plurality of capacitors according to an input duty ratio.

According to another aspect, there is provided a wireless power transmission apparatus including an inverter configured to convert input power to a current, a transmission circuit configured to wirelessly transmit power having an extended frequency band when the current is applied, and a processor configured to identify transmission parameters related to a variation in a transmission frequency at which the power is wirelessly transmitted, and control the inverter based on the transmission parameters.

The processor may be configured to control the inverter so that the transmission circuit transmits the transmission parameters during a communication period, and control the inverter so that the transmission circuit wirelessly transmits the power according to the transmission parameters during a power period.

According to another aspect, there is provided a wireless power reception method including determining reception parameters related to a resonant frequency of a reception circuit based on transmission parameters, and controlling an inductance of a matching inductor and a capacitance of a matching capacitor based on the reception parameters, the matching inductor and the matching capacitor being included in the reception circuit, wherein the transmission parameters are related to a variation in a transmission frequency at which power having an extended frequency band is wirelessly transmitted.

The determining of the reception parameters may include identifying the transmission parameters received in the reception circuit during a communication period, and determining the reception parameters during a power period using the transmission parameters.

The determining of the reception parameters may include detecting a current applied to the matching inductor, extracting a frequency component of the current, and identifying the transmission parameters.

The determining of the reception parameters may include determining the reception parameters based on a matching table in which the reception parameters corresponding to each of the transmission parameters are determined in advance.

The matching inductor may include a plurality of inductors, and a first switch block configured to control the inductance of the matching inductor by combining connections of the plurality of inductors.

The matching capacitor may include a plurality of capacitor banks, and a second switch block configured to control the capacitance of the matching capacitor by combining connections of the plurality of capacitor banks.

The matching capacitor may include a plurality of capacitors connected in parallel, and a plurality of duty switches connected to each of the plurality of capacitors and configured to control the capacitance of the matching capacitor by changing an effective capacitance of each of the plurality of capacitors according to an input duty ratio.

According to another aspect, there is provided a wireless power transmission method including identifying transmission parameters related to a variation in a transmission frequency at which power is wirelessly transmitted, and controlling an inverter configured to convert input power to a current, based on the transmission parameter, wherein the current is applied to a transmission circuit configured to wirelessly transmit power having an extended frequency band.

The controlling of the inverter may include controlling the inverter so that the transmission circuit transmits the transmission parameters during a communication period, and controlling the inverter so that the transmission circuit wirelessly transmits the power according to the transmission parameters during a power period.

Additional aspects of example embodiments will be set forth in part in the description which follows and, in part, will be apparent from the description, or may be learned by practice of the disclosure.

According to various example embodiments, it is possible to reduce electromagnetic wave (EMF/EMC) emission components in a wireless power transmission or wireless charging system, using a spread spectrum scheme, and possible to maintain and increase a total system efficiency for a transmission frequency that changes in real time.

According to various example embodiments, an EMF reduction effect may be obtained by reducing a magnitude of a fundamental frequency component using a spread spectrum scheme, in comparison to an existing technology of using a single frequency. Due to a reduction in the magnitude of the fundamental frequency component, an effect of reducing third or higher-order harmonic components may be obtained. Thus, through the spread spectrum scheme, an effect of reducing all components of EMF/EMC.

According to various example embodiments, in a spread spectrum scheme in which a transmission frequency component is variable, it is possible to reduce electromagnetic wave emission while maximally or optimally maintaining a system transmission efficiency by optimally matching a variable transmission frequency.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a wireless power transmission/reception system according to an example embodiment;

FIG. 2 is a diagram illustrating a communication period and a power period according to an example embodiment;

FIGS. 3A and 3B are diagrams illustrating examples of a frequency band of wireless power according to an example embodiment;

FIGS. 4A to 4C are diagrams illustrating examples of a transmission frequency at which power is wirelessly transmitted and which varies based on transmission parameters according to an example embodiment;

FIG. 5 is a diagram illustrating a transmission circuit of a wireless power transmission apparatus according to an example embodiment;

FIG. 6 is a diagram illustrating a matching inductor according to an example embodiment;

FIGS. 7 and 8 are diagrams illustrating examples of a matching capacitor according to an example embodiment;

FIG. 9 is a flowchart illustrating a wireless power reception method according to an example embodiment; and

FIG. 10 is a flowchart illustrating a wireless power transmission method according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

In a wireless power transmission/reception system for wirelessly transmitting and receiving power according to a single transmission frequency, a receiver for wirelessly receiving power may have a fixed matching value corresponding to a single transmission frequency. However, when a spread spectrum technology is applied to reduce EMC/EMF electromagnetic wave components, a transmission frequency of a transmitter for wirelessly transmitting power may change over time, but a matching value of a receiver, that is, matching of a reception inductor may be fixed. Thus, a wireless power transmission/reception efficiency may be reduced.

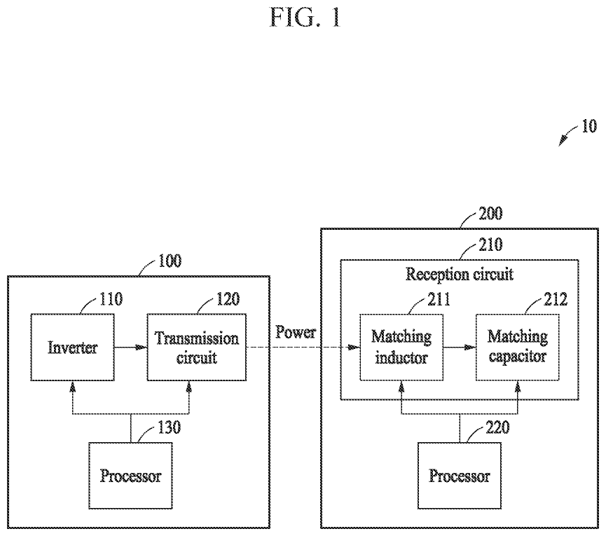

FIG. 1 is a diagram illustrating a wireless power transmission/reception system 10 according to an example embodiment. Referring to FIG. 1, the wireless power transmission/reception system 10 may include a wireless power transmission apparatus 100, a wireless power reception apparatus 200, and a clock generator.

Referring to FIG. 1, the wireless power transmission apparatus 100 of the wireless power transmission/reception system 10 may wirelessly transmit power having an extended frequency band, and a transmission frequency at which the power is wirelessly transmitted may vary according to transmission parameters. The wireless power reception apparatus 200 of the wireless power transmission/reception system 10 may wirelessly receive power having an extended frequency band. The wireless power reception apparatus 200 may increase an efficiency of the wireless power transmission/reception system 10 by controlling reception parameters according to a change in a transmission frequency at which power is wirelessly transmitted. A frequency band of power wirelessly transmitted according to a frequency of a clock generated by the clock generator may be extended.

The wireless power transmission/reception system 10 may wirelessly transmit and receive power that has an extended frequency band at a transmission frequency variable depending on transmission parameters.

The wireless power transmission/reception system 10 may control the wireless power reception device 200 to control the reception parameters if the transmission frequency changes, that is, continuously or arbitrarily discontinuously changes over time. The wireless power reception apparatus 200 of the wireless power transmission/reception system 10 may be matched (or resonated) at the transmission frequency at which power is wirelessly transmitted, and may prevent a decrease in a wireless power transmission/reception efficiency.

In other words, even when power is wirelessly transmitted according to a variable transmission frequency in the wireless power transmission/reception system 10, the wireless power reception apparatus 200 for wirelessly receiving power by controlling reception parameters may resonate at the variable transmission frequency.

In addition, since power wirelessly transmitted in the wireless power transmission/reception system 10 has an extended frequency band, third or higher-order harmonic components and a magnitude of a fundamental frequency component may be reduced in comparison to a system for wirelessly transmitting and receiving power using a single transmission frequency. Thus, a number of components of EMF/EMC may be reduced.

Referring to FIG. 1, the wireless power transmission apparatus 100 may include an inverter 110 configured to convert input power to a current, a transmission circuit 120 configured to wirelessly transmit power having an extended frequency band when the current is applied, and a processor 130 configured to identify transmission parameters related to a variation in a transmission frequency at which power is wirelessly transmitted and to control the inverter 110 based on the transmission parameters. The wireless power transmission apparatus 100 may wirelessly transmit power having an extended frequency band at a transmission frequency variable depending on the transmission parameters.

For example, power input to the inverter 110 of the wireless power transmission apparatus 100 may be converted to a current. The inverter 110 may be connected to the transmission circuit 120, and the current obtained by the inverter 110 may be applied to the transmission circuit 120.

The processor 130 may control the inverter 110 based on the transmission parameters, so that a frequency band of the current obtained by the inverter 110 may be extended and a center frequency may be changed. For example, direct current (DC) power may be input to the inverter 110 and converted to an alternating current (AC).

For example, the processor 130 may control a switching element, a clock generator that inputs a clock to the inverter 110, and the like, based on the transmission parameters, and a frequency band, and a transmission frequency (or a center frequency), and the like for the current obtained by the inverter 110 may be determined based on a control of the processor 130.

A current may be applied to the transmission circuit 120 of the wireless power transmission apparatus 100, and power having an extended frequency band may be wirelessly transmitted. For example, the transmission circuit 120 may include a transmission inductor 121, a transmission capacitor 122, and the like. Power may be wirelessly transmitted by a current applied to the transmission inductor 121.

A frequency band for wirelessly transmitting power, that is, a transmission frequency at which power is wirelessly transmitted may be determined according to a current applied to the transmission inductor 121. The processor 130 may control the inverter 110 based on the transmission parameters to control a frequency, a frequency band, and the like of the current applied to the transmission circuit 120. The processor 130 may control the current applied to the transmission circuit 120 to determine a frequency band, a transmission frequency, a transmission frequency variation rule, and the like of power wirelessly transmitted by the transmission circuit 120.

The processor 130 of the wireless power transmission apparatus 100 may identify transmission parameters related to a variation in a transmission frequency at which power is wirelessly transmitted, and may control the inverter 110 based on the transmission parameters.

The transmission parameters may be related to a variation in a transmission frequency at which power is wirelessly transmitted, and may include a transmission frequency, a transmission frequency variation rule, a frequency bandwidth, a frequency maintenance interval, synchronization information, and the like.

For example, the processor 130 may identify transmission parameters. The transmission parameters including a transmission frequency, a transmission frequency variation rule, a frequency bandwidth, a frequency maintenance interval, synchronization information, and the like, may be determined in advance. The transmission parameters may be determined from among a plurality of predetermined transmission parameters according to a channel environment of the wireless power transmission apparatus 100 or the wireless power reception apparatus 200. In addition, the processor 130 may receive a transmission parameter from an external device, and the like.

In an example, the processor 130 may identify transmission parameters and determine a transmission frequency at which power is wirelessly transmitted. For example, transmission parameters may include a transmission frequency, a transmission frequency variation rule, a frequency maintenance interval, that repeatedly change every time T2 with a transmission frequency f1 during a period of an initial time 0 to a time T1 and a transmission frequency f2 during a period of the time T1 to the time T2, and a frequency bandwidth which is 2Δf.

The processor 130 may identify the transmission parameters as described above, and control the inverter 110 so that a transmission frequency with the frequency bandwidth of 2Δf may repeatedly change every time T2 as described above.

The processor 130 may control the inverter 110 so that the transmission frequency of the power may be changed as described above for a time corresponding to the frequency maintenance interval included in the transmission parameters.

In addition, the transmission parameters may be related to a continuously changed transmission frequency. For example, the transmission parameters may include a transmission frequency, a transmission frequency variation rule, a frequency bandwidth, a frequency maintenance interval, that equally vary every period T so that the transmission frequency may constantly increase from f0 to f0+Δf up to T/4, that the transmission frequency may constantly decrease from f0+Δf to f0−Δf during a period of T/4 to 3T/4, and that the transmission frequency may constantly increase from f0−Δf to f0 during a period of 3T/4 to T. In this example, the frequency bandwidth may be 2Δf.

The processor 130 may identify continuously changing transmission parameters as described above, and may control the inverter 110 during the frequency maintenance interval so that the transmission frequency at which power is wirelessly transmitted may have a frequency bandwidth of 2Δf and may equally vary every period T as described above.

The transmission parameters may be related to a transmission frequency that is changed in various ways in addition to the above-described variation of the transmission frequency.

For example, the processor 130 may control the inverter 110 based on the transmission parameters. The current obtained by the inverter 110 may be determined according to a switching element, a clock, and the like, as described above. For example, the processor 130 may control the inverter 110 by changing a frequency of a clock input to the inverter 110 based on a transmission parameter. In addition, the processor 130 may control the inverter 110 by controlling, for example, an operation of the switching element or a signal input to the switching element.

In other words, the processor 130 may control the inverter 110 based on the transmission parameters, to control a frequency, a frequency band, and the like of the current to which the power input to the inverter 110 is converted.

In an example, the transmission parameters may indicate a set rule about a variation of a transmission frequency. The processor 130 may identify the transmission parameters and control the inverter 110 so that the transmission frequency may change according to the set rule about the variation of the transmission frequency.

Thus, the wireless power transmission apparatus 100 may wirelessly transmit power with an extended frequency band according to a transmission frequency that varies according to the transmission parameters.

Referring to FIG. 1, the wireless power reception apparatus 200 according to an embodiment may include a reception circuit 210, which includes a matching inductor 211 configured to wirelessly receive power having an extended frequency band and with an adjusted inductance, and a matching capacitor 212 with an adjusted capacitance, and a processor 130 configured to determine reception parameters related to a resonant frequency of the reception circuit 210 based on transmission parameters, and control the inductance and the capacitance based on the reception parameters. The transmission parameters may be related to a variation in a transmission frequency at which the power is wirelessly transmitted.

The wireless power reception apparatus 200 may wirelessly receive power having an extended frequency band at a variable transmission frequency. The wireless power reception apparatus 200 may increase a wireless power reception efficiency by controlling the reception parameters according to the transmission parameters related to the variation in the transmission frequency.

That is, the wireless power reception apparatus 200 may efficiently wirelessly receive power with a variable transmission frequency by controlling the reception parameters according to the transmission parameters.

The reception circuit 210 of the wireless power reception apparatus 200 may wirelessly receive power having an extended frequency band, and may include the matching inductor 211 with an adjusted inductance, and the matching capacitor 212 with an adjusted capacitance.

The matching inductor 211 and the matching capacitor 212 of the reception circuit 210 may be a variable inductor of which the inductance may be adjusted, and a variable capacitor of which a capacitance may be adjusted, respectively, and accordingly a resonant frequency of the reception circuit 210 may be determined based on the inductance of the matching inductor 211 and the capacitance of the matching capacitor 212.

The matching inductor 211 may include a plurality of inductors and a first switch block 230 to control the inductance, which will be described below. The matching capacitor 212 may include a plurality of capacitors and a plurality of duty switches 250 to control the capacitance, or may include a plurality of capacitor banks and a second switch block 240.

Power may be wirelessly received by magnetic resonance according to power wirelessly transmitted from the matching inductor 211 of the reception circuit 210. When a resonant frequency of the reception circuit 210 determined by the inductance and the capacitance matches the transmission frequency at which the power is wirelessly transmitted, a gain of the wirelessly received power may be maximized.

Near the resonant frequency, which is a characteristic of the reception circuit 210 determined based on the inductance of the matching inductor 211 and the capacitance of the matching capacitor 212 in the wireless power reception apparatus 200, a wireless power transmission efficiency may be extremely sensitively changed according to frequency characteristics. For example, when the resonant frequency of the reception circuit 210 of the wireless power reception apparatus 200 does not match the transmission frequency at which the power is wirelessly transmitted, a wireless power reception efficiency of the reception circuit 210 may rapidly decrease.

The processor 220 of the wireless power reception apparatus 200 may determine reception parameters related to the resonant frequency of the reception circuit 210 based on the transmission parameters, and control the inductance and capacitance according to the reception parameters.

As described above, the transmission parameters may be related to a variation in a transmission frequency at which power is wirelessly transmitted, and may include a transmission frequency, a transmission frequency variation rule, a frequency bandwidth, a frequency maintenance interval, synchronization information, and the like.

The processor 220 may determine reception parameters related to the resonant frequency of the reception circuit 210 according to the transmission parameters. For example, the reception parameters may be related to the resonant frequency of the reception circuit 210, and may include a resonant frequency, a resonant frequency variation rule, a frequency maintenance interval, synchronization information, an inductance and a capacitance for the resonant frequency, and the like.

The processor 220 may determine reception parameters according to the transmission parameters. The processor 220 may determine the resonant frequency, the resonant frequency variation rule, the frequency maintenance interval, the synchronization information, and the inductance and the capacitance for the resonant frequency of the reception parameters to correspond to the transmission frequency, the transmission frequency variation rule, the frequency maintenance interval, and the synchronization information of the transmission parameters.

The processor 220 may determine a resonant frequency that causes the resonant frequency of the reception circuit 210 to be changed to be the same as the transmission frequency, and a resonant frequency variation rule, and may determine an inductance and a capacitance such that the resonant frequency may be the same as the transmission frequency.

For example, as described above, transmission parameters may include a transmission frequency, a transmission frequency variation rule, a frequency maintenance interval, that repeatedly change every time T2 with a transmission frequency f1 during a period of an initial time 0 to a time T1 and a transmission frequency f2 during a period of the time T1 to the time T2, and the frequency bandwidth which is 2Δf.

In response to the above-described transmission parameters, the processor 220 may determine reception parameters with an inductance L1 and a capacitance C1 for a resonant frequency f1 during the period of the initial time 0 to the time T1 and an inductance L2 and a capacitance C2 for a resonant frequency f2 during the period of the time T1 to the time T2. The processor 220 may determine the frequency maintenance interval of the reception parameters to be the same as the frequency maintenance interval of the transmission parameters.

The processor 220 may control an inductance and a capacitance based on reception parameters. The processor 220 may control the inductance and capacitance based on the reception parameters, so that the resonant frequency of the reception circuit 210 may match the transmission frequency.

In other words, in an example of the inductance L1 and the capacitance C1 for the resonant frequency f1 during the period of the initial time 0 to the time T1 and the inductance L2 and the capacitance C2 for the resonant frequency f2 during the period of the time T1 to the time T2, the processor 220 may control the inductance and capacitance based on the reception parameters. The resonant frequency of the reception circuit 210 may match the transmission frequency at which power is wirelessly transmitted, based on a control of the processor 220, and accordingly a wireless power transmission/reception efficiency may be increased even though the transmission frequency is changed.

Even when transmission parameters continuously change, the processor 220 may determine reception parameters in the same manner and control the inductance and capacitance according to the reception parameters. That is, the processor 220 may determine an inductance and a capacitance for the resonant frequency such that the resonant frequency of the reception circuit 210 may continuously change to be the same as the transmission frequency. In addition, the processor 220 may control the inductance and capacitance according to the reception parameters.

Thus, the wireless power reception apparatus 200 may wirelessly receive power with an extended frequency band at a variable transmission frequency. The wireless power reception apparatus 200 may control the inductance and capacitance of the reception circuit 210 to which power is wirelessly received, may adjust the resonant frequency of the reception circuit 210, and may allow the resonant frequency of the reception circuit 210 to match the transmit frequency.

For example, the synchronization information of the transmission parameters may be information used by the wireless power transmission apparatus 100 and the wireless power reception apparatus 200 to transmit and receive transmission parameters during a communication period and to wirelessly transmit and receive power during a power period.

Based on the synchronization information, the wireless power transmission apparatus 100 may transmit a transmission parameter, and the wireless power reception apparatus 200 may receive the transmission parameter in the communication period. Based on the synchronization information, the wireless power transmission apparatus 100 may wirelessly transmit power and the wireless power reception apparatus 200 may wirelessly receive power in the power period.

For example, the wireless power reception apparatus 200 may identify transmission parameters or determine reception parameters using wirelessly received power, to increase the wireless power reception efficiency. The wireless power reception apparatus 200 may extract a frequency component by detecting a current applied to the matching inductor 211, may identify transmission parameters based on a phase difference between the current applied to the matching inductor 211 of the wireless power reception apparatus 200 and a current applied to the transmission inductor 121 of the wireless power transmission apparatus 100, and may determine reception parameters.

Referring to FIG. 1, the wireless power reception apparatus 200 may detect the current applied to the matching inductor 211, extract a frequency component of the current, and identify transmission parameters. The wireless power reception apparatus 200 may detect a waveform, a magnitude, and a phase of the current applied to the matching inductor 211, and may extract the frequency component of the current.

The frequency component of the current applied to the matching inductor 211 may be related to a transmission frequency of a wirelessly transmitted power, and the transmission parameters may be identified using the extracted frequency component of the current.

Referring to FIG. 1, the wireless power reception apparatus 200 may determine a reception parameter based on a matching table in which reception parameters corresponding to each transmission parameter are determined in advance. The wireless power reception apparatus 200 may determine a reception parameter based on a matching table in which reception parameters corresponding to each transmission parameter are determined in advance, to shorten an operation process for determining a reception parameter corresponding to a transmission parameter. In addition, the wireless power reception apparatus 200 may quickly determine reception parameters in response to a variation in a transmission frequency, and control an inductance and a capacitance.

The matching table may include predetermined reception parameters corresponding to each transmission parameter. The reception parameters may include, for example, a corresponding resonant frequency, a resonant frequency variation rule, and an inductance and a capacitance for a resonant frequency, and the like, for each transmission parameter.

For example, if a transmission parameter is related to a variation in a transmission frequency that repeatedly changes every time T2 with a transmission frequency f1 during a period of an initial time 0 to a time T1 and a transmission frequency f2 during a period of the time T1 to the time T2, reception parameters corresponding to the transmission parameter in the matching table may be an inductance L1 and a capacitance C1 of a resonant frequency f1 during the period of the initial time 0 to the time T1 and an inductance L2 and a capacitance C2 of a resonant frequency f2 during the period of the time T1 to the time T2.

For example, in the matching table, an inductance and a capacitance that allow the resonant frequency to match the transmission frequency may be determined in advance. In an example, based on a power loss, an inductance and a capacitance that allow the resonant frequency to match the transmission frequency may be determined in advance in the matching table. Accordingly, when the transmission frequency is changed, different inductances and capacitors may be determined in advance in the matching table according to the transmission frequency that is not changed, even though the transmission frequency is maintained.

Referring to FIG. 1, the wireless power transmission/reception system 10 may determine a reception parameter based on a phase of the current applied to the transmission inductor 121 and a phase of the current applied to the matching inductor 211. When the phase difference between the transmission inductor 121 and the matching inductor 211 is 90 degrees, the transmission inductor 121 and the matching inductor 211 may be in an optimal matching state. Accordingly, by monitoring the phase difference between the transmission inductor 121 and the matching inductor 211, the reception parameter may be determined so that the phase difference may be 90 degrees.

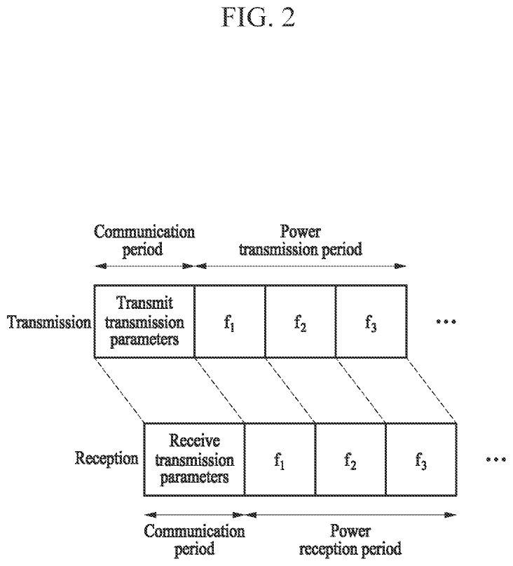

FIG. 2 is a diagram illustrating a communication period and a power period according to an example embodiment.

Referring to FIG. 2, the processor 130 of the wireless power transmission apparatus 100 according to an example embodiment may control the inverter 110 so that the transmission circuit 120 may transmit transmission parameters during a communication period, and may control the inverter 110 so that the transmission circuit 120 may wirelessly transmit power according to the transmission parameters during the power period.

Referring to FIG. 2, the processor 220 of the wireless power reception apparatus 200 according to an example embodiment may identify transmission parameters received in the reception circuit 210 during the communication period, and may determine reception parameters during the power period using the transmission parameters.

Referring to FIG. 2, the processor 130 of the wireless power transmission apparatus 100 may control the inverter 110 so that the transmission circuit 120 may transmit a transmission parameter during the communication period.

As shown in FIG. 2, the wireless power transmission apparatus 100 may allow transmission parameters to be transmitted during the communication period. The transmission parameters may be related to a variation in the transmission frequency, and the wireless power transmission apparatus 100 may control the inverter 110 so that the transmission circuit 120 may transmit a transmission frequency, a transmission frequency variation rule, a frequency bandwidth, a frequency maintenance interval, synchronization information, and the like as signals.

Referring to FIG. 2, the processor 220 of the wireless power reception apparatus 200 may identify transmission parameters received in the reception circuit 210 during the communication period, and may determine reception parameters during the power period based on the transmission parameters. In FIG. 2, it may be confirmed that a transmission parameter is received during the communication period in the wireless power reception apparatus 200.

In an example, a transmission parameter may be transmitted during the communication period, based on a magnitude, a frequency, a pattern, and the like, of a signal. For example, when a transmission frequency at which power is wirelessly transmitted changes to f1, f2, and f3 during the power period, as shown in FIG. 2, the inverter 110 may be controlled so that a signal may be transmitted in an order in which a frequency of the signal changes to f1, f2, and f3 during the communication period. A period of time during which transmission frequencies f1, f2, and f3 are maintained in the power period may indicate a time ratio in which frequencies of signals transmitted during the communication period are f1, f2, and f3, respectively, within the communication period.

The wireless power reception apparatus 200 may identify transmission parameters received during the communication period. As described above, the frequency of the signal received during the communication period may change in the order of f1, f2, and f3, and the transmission frequency may discontinuously change in the order of f1, f2, and f3 during the power period based on a time ratio in which the frequencies f1, f2, and f3 of the signal in the communication period are received, and a time in which each of transmission frequencies f1, f2, and f3 is maintained may be used to identify transmission parameters determined based on the time ratio in which the frequencies f1, f2, and f3 of the signal in the communication period are received.

The wireless power reception apparatus 200 may determine a reception parameter during the power period based on the identified transmission parameters, and may control an inductance and a capacitance according to the reception parameter.

The wireless power transmission apparatus 100 may control the inverter 110 so that a signal for identifying the communication period may be transmitted. The signal for identifying the communication period may correspond to a synchronization signal used by the wireless power transmission apparatus 100 and the wireless power reception apparatus 200 to transmit and receive transmission parameters in the communication period and to wirelessly transmit and receive power in the power period.

For example, the wireless power transmission apparatus 100 may control the inverter 110 so that a signal having a preset synchronization frequency may be transmitted. A plurality of preset synchronization frequencies may be provided, and each of the synchronization frequencies may be a length of each of a communication period and a power period, a transmission frequency variation rule, and the like.

For example, when a signal of a preset synchronization frequency f1 is transmitted, a communication period T1, a power period T2, and the transmission frequency variation rule may indicate that the transmission frequency is discontinuously changed. When a signal of a preset synchronization frequency f2 is transmitted, a communication period T3, a power period T4, and the transmission frequency variation rule may indicate that the transmission frequency is continuously changed.

The wireless power reception apparatus 200 may receive a signal for identifying a communication period. The wireless power reception apparatus 200 may determine a length of each of the communication period and the power period, the transmission frequency variation rule, and the like according to the received signal for identifying the communication period. As described above, when the preset synchronization frequency f1 is received, the communication period T1, the power period T2, and the transmission frequency variation rule may indicate that the transmission frequency discontinuously changes.

The above-described transmission parameters or variation in the transmission frequency according to the transmission parameters are not limited to the above examples, and various examples of the transmission frequency variable depending on transmission parameters, which will be described below, may be applied.

Similarly, description of identifying transmission parameters received during a communication period and determining reception parameters during a power period based on the transmission parameters in the wireless power reception device 200 is not limited to the above examples, and various transmission parameters related to transmission frequencies, a transmission frequency variation rule, a frequency maintenance time, and the like may be applied.

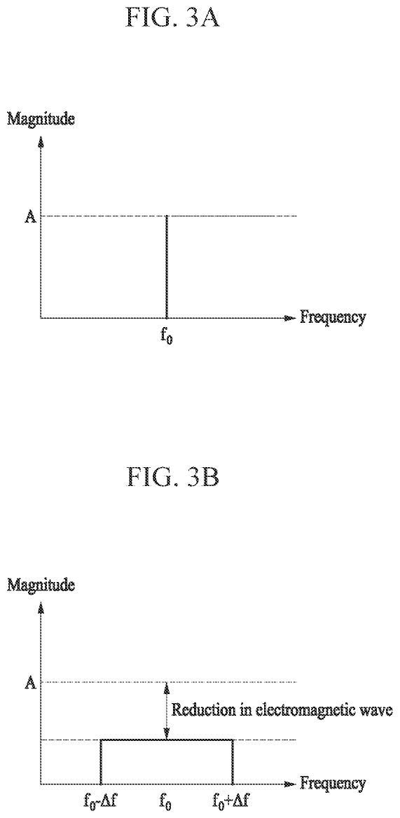

FIGS. 3A and 3B are diagrams illustrating examples of a frequency band of wireless power according to an example embodiment.

FIG. 3A illustrates a magnitude of power wirelessly transmitted at a single frequency, and FIG. 3B illustrates a magnitude of wireless power having an extended frequency band according to an example embodiment.

As shown in FIG. 3B, a frequency band of power wirelessly transmitted and received according to an example embodiment may be extended to a frequency band of 2Δf based on f0. In an example in which channel powers of FIGS. 3A and 3B are the same, if the frequency band is extended as shown in FIG. 3B, a magnitude of wirelessly transmitted power may be reduced, thereby reducing a fundamental frequency component and electromagnetic wave emission.

In other words, the wireless power transmission apparatus 100 may wirelessly transmit power having an extended frequency band, so that electromagnetic wave emission may be reduced. The wireless power reception apparatus 200 may wirelessly receive the power having the extended frequency band.

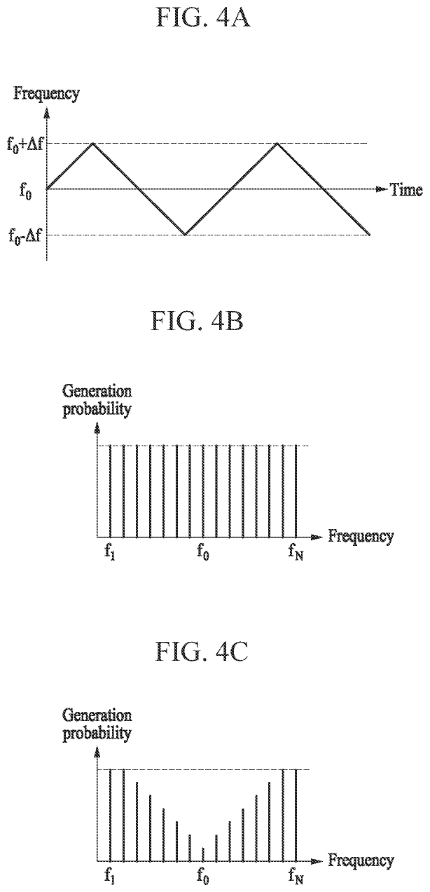

FIGS. 4A to 4C are diagrams illustrating examples of a transmission frequency at which power is wirelessly transmitted and which varies based on transmission parameters according to an example embodiment. A transmission parameter may be related to a variation in a transmission frequency at which power is wirelessly transmitted, and FIGS. 4A, 4B, and 4C illustrate transmission frequencies of power wirelessly transmitted according to different transmission parameters over time.

FIG. 4A illustrates a transmission frequency that is continuously variable within a constant bandwidth 2Δf in a continuous frequency sweep manner. Based on the transmission parameters, the transmission frequency may constantly increase from f0 to f0+Δf, constantly decrease from f0+Δf to f0−Δf, and constantly increase again to f0. Subsequently, the above operation may be repeated so that the transmission frequency may be variable.

FIGS. 4B and 4C illustrate a random frequency generation scheme in which a transmission frequency changes according to a probability, and are graphs showing generation probability of each frequency. FIG. 4B illustrates an example in which frequency generation probabilities are the same, and FIG. 4C illustrates an example in which frequencies are nonuniformly generated by assigning weights for each frequency. In the example of FIG. 4C, an EMF/EMC electromagnetic wave emission level may be changed by changing a channel environment or a form of frequency spreading.

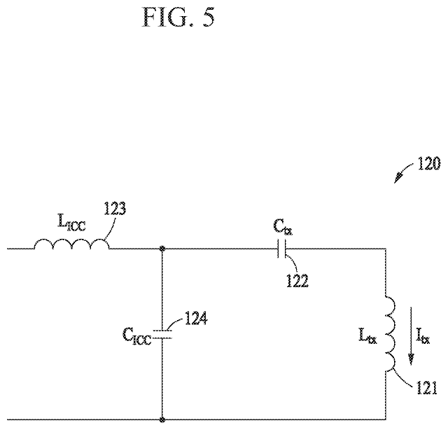

FIG. 5 is a diagram illustrating a transmission circuit 120 of a wireless power transmission apparatus 100 according to an example embodiment.

FIG. 5 illustrates the transmission circuit 120 by changing matching of the inverter 110 to reduce electromagnetic waves. A square wave output of the inverter 110 may be changed to a pure sine wave form (e.g., a sine wave) with an LCC matching structure, to reduce electromagnetic waves, and in particular, reduce third or higher-order harmonic components.

Referring to FIG. 5, the transmission circuit 120 may include a transmission inductor 121 Ltx and a transmission capacitor 122 Ctx. The transmission inductor 121 and the transmission capacitor 122 may be connected in series. An LCC capacitor 124 may be connected in parallel to the transmission inductor 121 and the transmission capacitor 122 that are connected in series. An LCC inductor 123 may be connected to a contact point between the LCC capacitor 124, and the transmission inductor 121 and the transmission capacitor 122 that are connected in series.

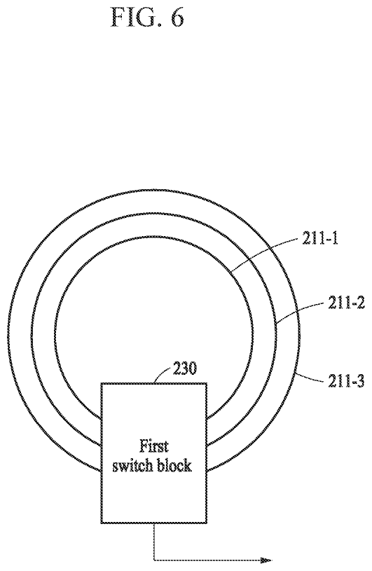

FIG. 6 is a diagram illustrating a matching inductor 211 according to an example embodiment. The matching inductor 211 of FIG. 6 may include a first matching inductor 211-1 through a third matching inductor 211-3, and a first switch block 230.

Referring to FIG. 6, the matching inductor 211 may include a plurality of inductors, and the first switch block 230 configured to control an inductance of the matching inductor 211 by combining connections of the plurality of inductors.

The first switch block 230 may control the inductance of the matching inductor 211 by combining the connections of the plurality of inductors. In other words, the first switch block 230 may connect at least two of the plurality of inductors in series or in parallel.

In an example, in FIG. 6, the first switch block 230 may connect the first matching inductor 211-1 and a second matching inductor 211-2 in series or parallel, or may connect the first matching inductor 211-1 through the third matching inductor 211-3 in parallel. In another example, the first switch block 230 may connect the first matching inductor 211-1 and the second matching inductor 211-2 in parallel, and connect the first matching inductor 211-1 and the third matching inductor 211-3 in series.

Since the inductance of the matching inductor 211 changes according to the connections of the plurality of inductors, the wireless power reception apparatus 200 may control the inductance of the matching inductor 211 by combining the connections of the plurality of inductors using the first switch block 230. A number of the plurality of inductors and a method of combining the connections of the plurality of inductors by the first switch block 230 are not limited thereto.

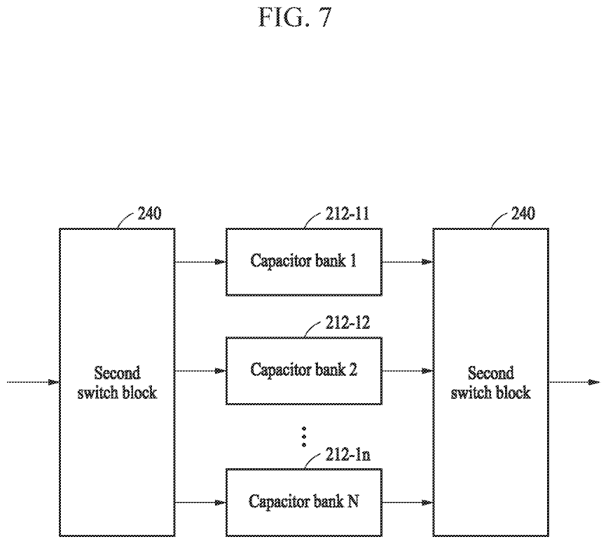

FIGS. 7 and 8 are diagrams illustrating examples of a matching capacitor 212 according to an example embodiment. FIG. 7 illustrates the matching capacitor 212 including “N” capacitor banks 212-11 to 212-1n and a second switch block 240, and FIG. 8 illustrates the matching capacitor 212 including “N” capacitors 212-1 to 212-n and “N” duty switches 250.

Referring to FIG. 7, the matching capacitor 212 may include a plurality of capacitor banks, and the second switch block 240 configured to control a capacitance of the matching capacitor 212 by combining connections of the plurality of capacitor banks.

The second switch block 240 may control the capacitance of the matching capacitor 212 by combining the connections of the plurality of capacitor banks. For example, the second switch block 240 may connect a capacitor bank 1 212-11 to a capacitor bank N 212-1n in series or parallel, or connect the capacitor bank 1 212-11 and a capacitor bank 2 212-12 in series or parallel.

Since the capacitance of the matching capacitor 212 changes according to the connections of the plurality of capacitor banks, the wireless power reception apparatus 200 may control the capacitance of the matching capacitor 212 by combining the connections of the plurality of capacitor banks using the second switch block 240.

For example, it may be possible to further combine capacitors in series or parallel in each of the plurality of capacitor banks, and capacitor banks may be added or expanded by successively cascading another plurality of capacitor banks and another second switch block 240 to the plurality of capacitor banks and the second switch block 240.

Referring to FIG. 8, the matching capacitor 212 may include a plurality of capacitors connected in parallel, and a plurality of duty switches 250 connected to each of the plurality of capacitors and configured to control a capacitance of the matching capacitor 212 by changing an effective capacitance of each of the plurality of capacitors according to an input duty ratio.

In FIG. 8, the plurality of capacitors may be connected in parallel, and a duty switch 250 may be connected to each of the plurality of capacitors 212-1 to 212-n. The duty switch 250 may change an effective capacitance of a connected capacitor according to the input duty ratio. If a duty ratio of a duty switch 250 connected to a capacitor is low, an effective capacitance of the capacitor connected to the duty switch 250 may have a low value. If the duty ratio of the duty switch 250 connected to the capacitor is high, the effective capacitance of the capacitor connected to the duty switch 250 may have a high value.

Accordingly, by changing a duty ratio of each of the “N” duty switches 250, an effective capacitance by the plurality of capacitors may be changed, and the capacitance of the matching capacitor 212 may be changed. In other words, since the capacitance of the matching capacitor 212 changes according to duty ratios of the plurality of duty switches 250, the wireless power reception apparatus 200 may control the capacitance of the matching capacitor 212 by combining connections of the plurality of capacitors using the second switch block 240.

If a current applied to the matching inductor 211 is zero, the wireless power reception apparatus 200 may control operations of the first switch block 230 and the second switch block 240. If a transmission frequency is changed according to transmission parameters, an inductance or a capacitance may be controlled based on reception parameters. If a magnitude of the current applied to the matching inductor 211 is “0”, an operation of the first switch block 230 or the second switch block 240 may be controlled, thereby minimizing a power loss.

For example, the wireless power reception apparatus 200 may include a zero current detector configured to detect a point at which a magnitude of a current applied to the matching inductor 211 is zero.

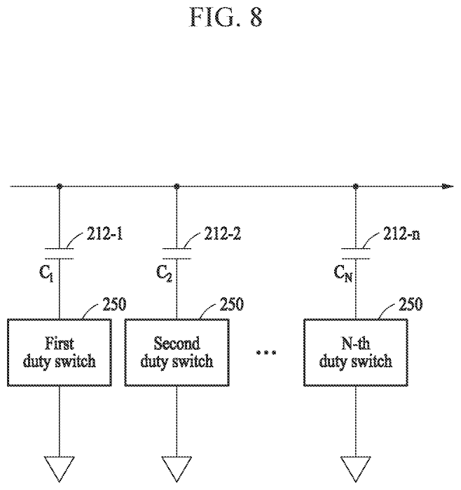

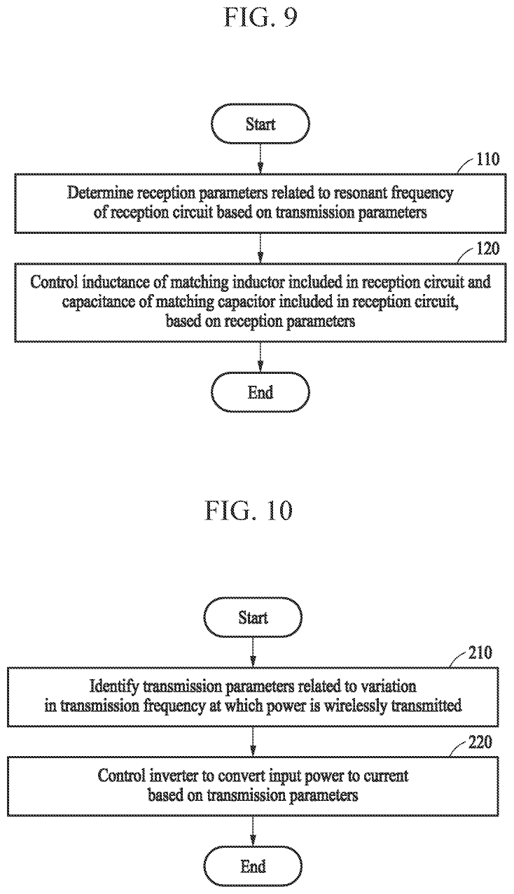

FIGS. 9 and 10 are diagrams illustrating a wireless power reception method and a wireless power transmission method, respectively. The wireless power reception method and the wireless power transmission method may be performed by the wireless power reception apparatus 200 and the wireless power transmission apparatus 100, respectively. Although the wireless power reception method and the wireless power transmission method are omitted in the following description, the description of the wireless power reception apparatus 200 and the wireless power transmitting apparatus 100 provided with reference to FIGS. 1 to 8 may equally apply to the wireless power reception method and the wireless power transmitting method.

FIG. 9 is a flowchart illustrating a wireless power reception method according to an example embodiment.

Referring to FIG. 9, the wireless power reception method may include determining reception parameters related to a resonant frequency of the reception circuit 210 based on transmission parameters, and controlling an inductance of the matching inductor 211 included in the reception circuit 210 and a capacitance of the matching capacitor 212 included in the reception circuit 210 according to the reception parameters. The transmission parameters may be related to a variation in a transmission frequency at which power having an extended frequency band is wirelessly transmitted.

Referring to FIG. 9, in operation 110, the wireless power reception apparatus 200 may determine reception parameters related to the resonant frequency of the reception circuit 210 based on transmission parameters. The transmission parameters may be related to a variation in a transmission frequency at which power having an extended frequency band is wirelessly transmitted, and may include, for example, a transmission frequency variation rule, a frequency maintenance time, and the like.

Reception parameters related to the resonant frequency of the reception circuit 210 may be determined based on transmission parameters related to a variable transmission frequency. Reception parameters related to a resonant frequency variation rule, a frequency maintenance time, and the like may be determined so that the variable transmission frequency and the resonant frequency may match. An inductance and a capacitance may be determined so that the variable transmission frequency and the resonant frequency may match.

In operation 120, the wireless power reception apparatus 200 may control the inductance of the matching inductor 211 in the reception circuit 210 and the capacitance of the matching capacitor 212 in the reception circuit 210 according to the reception parameters. The inductance of the matching inductor 211 and the capacitance of the matching capacitor 212 may be controlled according to an inductance and a capacitance that allow the resonant frequency and a variable transmission frequency of the determined reception parameters to match, thereby allowing the resonant frequency of the reception circuit 210 to match the transmission frequency, and increasing a wireless power reception efficiency.

FIG. 10 is a flowchart illustrating a wireless power transmission method according to an example embodiment.

Referring to FIG. 10, the wireless power transmission method may include identifying transmission parameters related to a variation in a transmission frequency at which power is wirelessly transmitted, and controlling the inverter 110 to convert input power to a current according to the transmission parameters. The current may be applied to the transmission circuit 120 to wirelessly transmit power with an extended frequency band.

Referring to FIG. 10, in operation 210, the wireless power transmission apparatus 100 may identify transmission parameters related to a variation in a transmission frequency at which power is wirelessly transmitted. The transmission parameters may be related to the variation in the transmission frequency, and may include, for example, a transmission frequency, a transmission frequency variation rule, a frequency maintenance time, synchronization information, and the like. In addition, the transmission parameters may be a rule about a variation in a transmission frequency at which power is wirelessly transmitted.

Next, in operation 220, the wireless power transmission apparatus 100 may control the inverter 110 to convert input power to a current according to the transmission parameters. The wireless power transmission apparatus 100 may control the inverter 110 based on a transmission frequency variation rule, a frequency maintenance time, and the like of the transmission parameters. For example, the wireless power transmission apparatus 100 may control the inverter 110 by controlling a clock generator that inputs a clock to the inverter 110 or a switching device that operates according to an input signal. Input power may be converted to a current in the inverter 110, the current may be applied to the transmission circuit 120, and accordingly power with an extended frequency band may be wirelessly transmitted based on a transmission frequency variable depending on transmission parameters.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single example embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A wireless power reception apparatus comprising:
a reception circuit configured to wirelessly receive power having an extended frequency band, the reception circuit comprising a matching inductor with an adjusted inductance and a matching capacitor with an adjusted capacitance; and
a processor configured to determine reception parameters related to a resonant frequency of the reception circuit based on transmission parameters and control the inductance and the capacitance based on the reception parameters,
wherein the transmission parameters are related to a variation in a transmission frequency at which the power is wirelessly transmitted.

2. The wireless power reception apparatus of claim 1, wherein the processor is configured to identify the transmission parameters received in the reception circuit during a communication period, and determine the reception parameters during a power period using the transmission parameters.

3. The wireless power reception apparatus of claim 1, wherein the processor is configured to detect a current applied to the matching inductor, extract a frequency component of the current, and identify the transmission parameters.

4. The wireless power reception apparatus of claim 1, wherein the processor is configured to determine the reception parameters based on a matching table in which the reception parameters corresponding to each of the transmission parameters are determined in advance.

5. The wireless power reception apparatus of claim 1, wherein the matching inductor comprises:
a plurality of inductors; and
a first switch block configured to control the inductance of the matching inductor by combining connections of the plurality of inductors.

6. The wireless power reception apparatus of claim 1, wherein the matching capacitor comprises:
a plurality of capacitor banks; and
a second switch block configured to control the capacitance of the matching capacitor by combining connections of the plurality of capacitor banks.

7. The wireless power reception apparatus of claim 1, wherein the matching capacitor comprises:
a plurality of capacitors connected in parallel; and
a plurality of duty switches connected to each of the plurality of capacitors and configured to control the capacitance of the matching capacitor by changing an effective capacitance of each of the plurality of capacitors according to an input duty ratio.

8. A wireless power transmission apparatus comprising:
an inverter configured to convert input power to a current;
a transmission circuit configured to wirelessly transmit power having an extended frequency band when the current is applied; and
a processor configured to identify transmission parameters related to a variation in a transmission frequency at which the power is wirelessly transmitted, and control the inverter based on the transmission parameters.

9. The wireless power transmission apparatus of claim 8, wherein the processor is configured to control the inverter so that the transmission circuit transmits the transmission parameters during a communication period, and control the inverter so that the transmission circuit wirelessly transmits the power according to the transmission parameters during a power period.

10. A wireless power reception method comprising:
determining reception parameters related to a resonant frequency of a reception circuit based on transmission parameters; and
controlling an inductance of a matching inductor and a capacitance of a matching capacitor based on the reception parameters, the matching inductor and the matching capacitor being included in the reception circuit,
wherein the transmission parameters are related to a variation in a transmission frequency at which power having an extended frequency band is wirelessly transmitted.

11. The wireless power reception method of claim 10, wherein the determining of the reception parameters comprises identifying the transmission parameters received in the reception circuit during a communication period, and determining the reception parameters during a power period using the transmission parameters.

12. The wireless power reception method of claim 10, wherein the determining of the reception parameters comprises detecting a current applied to the matching inductor, extracting a frequency component of the current, and identifying the transmission parameters.

13. The wireless power reception method of claim 10, wherein the determining of the reception parameters comprises determining the reception parameters based on a matching table in which the reception parameters corresponding to each of the transmission parameters are determined in advance.

14. The wireless power reception method of claim 10, wherein the matching inductor comprises:
a plurality of inductors; and
a first switch block configured to control the inductance of the matching inductor by combining connections of the plurality of inductors.

15. The wireless power reception method of claim 10, wherein the matching capacitor comprises:
a plurality of capacitor banks; and
a second switch block configured to control the capacitance of the matching capacitor by combining connections of the plurality of capacitor banks.

16. The wireless power reception method of claim 10, wherein the matching capacitor comprises:
a plurality of capacitors connected in parallel; and
a plurality of duty switches connected to each of the plurality of capacitors and configured to control the capacitance of the matching capacitor by changing an effective capacitance of each of the plurality of capacitors according to an input duty ratio.
